(19) United States
(12) Patent Application Publication
(10) Pub. No.: US 2026/0149164 A1
(43) Pub. Date: May 28, 2026

(54) ANTENNA ASSEMBLY AND ELECTRONIC DEVICE

(71) Applicant: GUANGDONG OPPO MOBILE TELECOMMUNICATIONS CORP., LTD., Dongguan (CN)

(72) Inventors: Zongshang LI, Dongguan (CN); Huanhong LIU, Dongguan (CN)

(21) Appl. No.: 19/402,311

(22) Filed: Nov. 26, 2025

(30) Foreign Application Priority Data
Nov. 26, 2024 (CN) 202411711243.6

(51) Int. Cl. H01Q 1/22; H01Q 5/30; H01Q 5/378; H01Q 21/28

(52) U.S. Cl. CPC H01Q 1/22; H01Q 5/30; H01Q 5/378; H01Q 21/28

(57) ABSTRACT

Provided are an antenna assembly and an electronic device. The antenna assembly includes a first antenna, a second antenna, and a third antenna. Each of the first, second and third antennas includes a radiator and a feed source. The radiators of the first and second antennas are coupled through a first gap therebetween, and the radiators of the second and third antennas are coupled through a second gap therebetween. The radiator of the first antenna is excited to support first and second frequency bands. The radiator of the second antenna is excited to support third and fourth frequency bands, and the radiators of the first and second antennas may be excited to jointly support the third and fourth frequency bands. The radiator of the third antenna and part of the radiator of the second antenna are excited to support the second frequency band and a WiFi 5G frequency band.

### CROSS-REFERENCE OF RELATED APPLICATION

This application claims priority to Chinese Patent Application No. 202411711243.6, filed Nov. 26, 2024, the entire disclosures of which are incorporated herein by reference.

### TECHNICAL FIELD

The present disclosure relates to the field of antenna technologies, and particularly to an antenna assembly and an electronic device.

### BACKGROUND

With the development of technology, electronic devices with communication functions, such as mobile phones and tablet computers, have become increasingly popular, and they offer more and more powerful functions and require coverage of more and more frequency bands. However, since the electronic devices are designed to be increasingly thin and lightweight, it has become a technical problem to be solved of how to improve the multi-band coverage of electronic devices while promoting the miniaturization of the electronic devices.

### SUMMARY

Embodiments of the present disclosure provide an antenna assembly and an electronic device.

The embodiments of the present disclosure provide an antenna assembly including:
a first antenna including a first radiator and a first feed source, where the first feed source is connected to a first feed point of the first radiator to excite the first radiator to support a first frequency band and a second frequency band;
a second antenna including a second radiator and a second feed source, where there is a first gap between a first terminal of the second radiator and the first radiator, and the second radiator is coupled with the first radiator through the first gap; the second radiator is provided with a second feed point and a ground strap point, the second feed point and the ground strap point are spaced apart from each other, the ground strap point is connected to a common ground terminal, and the second feed source is connected to the second feed point to excite the second radiator to support a third frequency band and a fourth frequency band, and to excite the first radiator and the second radiator to jointly support the third frequency band and the fourth frequency band, the fourth frequency band being a WiFi 2.4G frequency band or a Bluetooth 2.4G frequency band; and
a third antenna including a third radiator and a third feed source, where there is a second gap between the third radiator and a second terminal of the second radiator, and the third radiator is coupled with the second radiator through the second gap; and the third feed source is connected to a third feed point of the third radiator to excite the third radiator and a part of the second radiator to support the second frequency band and WiFi 5G.

The embodiments of the present disclosure further provide an electronic device, including the aforementioned antenna assembly.

### BRIEF DESCRIPTION OF THE DRAWINGS

To more clearly illustrate technical solutions in the embodiments of the present disclosure, drawings required for the description of the embodiments are briefly introduced below. Apparently, the drawings described below are only some embodiments of the present disclosure. For those of ordinary skill in the art, other drawings can also be obtained according to these drawings without creative work.

FIG. 1 is a schematic diagram illustrating an external structure of an electronic device according to an embodiment.

FIG. 2 is a schematic diagram illustrating a structure of an antenna assembly according to an embodiment.

FIG. 3 is a schematic diagram illustrating an antenna structure of an electronic device according to an embodiment.

FIG. 4 is a schematic diagram illustrating the structure of the antenna assembly according to another embodiment.

FIG. 5 is a schematic diagram illustrating a structure of a first antenna according to an embodiment.

FIG. 6 is a schematic diagram illustrating the structure of the first antenna according to another embodiment.

FIG. 7 is a diagram of simulated return loss waveforms of the first antenna in a free state according to an embodiment.

FIG. 8 is a diagram of simulated efficiency waveforms of the first antenna in supporting a first frequency band in the free state according to an embodiment.

FIG. 9 is a current distribution diagram of the first antenna in a second resonance mode according to an embodiment.

FIG. 10 is a diagram of simulated return loss waveform of the first antenna in a free scenario according to another embodiment.

FIG. 11 is a diagram of simulated efficiency waveforms of the first antenna in supporting a second frequency band in the free scenario according to an embodiment.

FIG. 12 is a schematic diagram of the electronic device in a landscape holding state according to an embodiment.

FIG. 13 is a diagram of simulated efficiency waveforms of the first antenna respectively in the free state and the landscape holding state according to an embodiment.

FIG. 14 is a diagram of simulated return loss waveform of a second antenna in the free state according to an embodiment.

FIG. 15 is a schematic diagram illustrating the structure of the antenna assembly according to yet another embodiment.

FIG. 16 is a schematic diagram illustrating the structure of the second antenna according to an embodiment.

FIG. 17 is a current distribution diagram of the second antenna in a third resonance mode according to an embodiment.

FIG. 18 is a current distribution diagram of the second antenna in a fourth resonance mode according to an embodiment.

FIG. 19 is a current distribution diagram of the second antenna in a fifth resonance mode according to an embodiment.

FIG. 20 is a current distribution diagram of the second antenna in a sixth resonance mode according to an embodiment.

FIG. 21 is a diagram of simulated efficiency waveforms of the second antenna in supporting a third frequency band and a fourth frequency band according to an embodiment.

FIG. 22 is a diagram of simulated efficiency waveforms of the second antenna respectively in the free state and the landscape holding state according to an embodiment.

FIG. 23 is a diagram of simulated return loss waveform of a third antenna according to an embodiment.

FIG. 24 is a schematic diagram illustrating the structure of the third antenna according to an embodiment.

FIG. 25 is a current distribution diagram of the third antenna in a sixth resonance mode according to an embodiment.

FIG. 26 is a current distribution diagram of the third antenna in a seventh resonance mode according to an embodiment.

FIG. 27 is a current distribution diagram of the third antenna in an eighth resonance mode according to an embodiment.

FIG. 28 is a schematic diagram illustrating the structure of the antenna assembly according to a further embodiment.

FIG. 29 is a current distribution diagram of the third antenna in a ninth resonance mode according to an embodiment.

FIG. 30 is a diagram of simulated efficiency waveforms of the third antenna with and without a parasitic branch according to an embodiment.

FIG. 31 is a diagram of simulated efficiency waveforms of the third antenna according to an embodiment.

FIG. 32 is a diagram of simulated efficiency waveforms of the third antenna respectively in the free state and the landscape holding state according to an embodiment.

FIG. 33 is a block diagram illustrating an internal structure of the electronic device according to an embodiment.

### DETAILED DESCRIPTION OF PREFERRED EMBODIMENTS

In order to make the purposes, technical solutions, and advantages of the present disclosure clearer, the present disclosure will be further described in detail below with reference to the accompanying drawings and embodiments. It is understandable that the specific embodiments described herein are only used to explain the present disclosure, rather than limiting the present disclosure.

It is understandable that terms “first”, “second”, etc. used in the present disclosure may be used to describe various elements herein, but these elements are not limited by these terms. These terms are only used to distinguish one element from another element, and cannot be understood as indicating or implying relative importance or implicitly indicating the number of indicated technical features. Thus, a feature defined by “first” or “second” may explicitly or implicitly include at least one such feature. In the description of the present disclosure, “plurality/multiple” means at least two, such as two or three, unless otherwise clearly and specifically limited. When an element is considered to be “connected” to another element, it may be directly connected to the other element or an intermediate element may exist additionally.

The electronic device involved in the embodiments of the present disclosure may be a handheld device, a vehicle-mounted device, a smart car, a wearable device, a computing device, or other processing devices connected to a wireless modem, as well as various forms of user equipment (UE) (e.g., mobile phones), mobile stations (MS), and the like. For convenience of description, the above-mentioned devices are collectively referred to as electronic devices.

Referring to FIG. 1, in an embodiment, it is illustrated by taking a case where the electronic device is a mobile phone as an example. The electronic device 100 includes a display screen assembly 110 and a housing (not shown in the figure). The display screen assembly 110 includes a display screen, and the display screen may be an organic light-emitting diode (OLED) screen or a liquid crystal display (LCD) screen. The display screen assembly 110 may be used to display information and provide an interactive interface for users. The display screen may be in a shape of rectangle or rounded rectangle. The rounded rectangle is sometimes also called a round rectangle, that is, the four corners of the rectangle are arc-shaped for transition, and the four sides of the rectangle are roughly straight line segments.

The housing includes a frame 120 and a back cover. The frame 120 may be made of a metal material such as aluminum alloy, magnesium alloy, or stainless steel, or may also be made of an insulating material such as plastic. The frame 120 is arranged on the outer periphery of the display screen assembly 110 to support and protect the display screen assembly 110. The frame 120 may further extend into the electronic device to define a middle plate. The integrally formed middle plate and frame 120 are sometimes also referred to as a middle frame. The back cover is arranged on a side opposite to the displayable area of the display screen and connected to the frame 120. Further, the display screen assembly 110 and the back cover are respectively located on opposite sides of the middle plate.

The frame 120 is roughly a rectangular frame, and includes a top side-frame 121 and a bottom side-frame 123 arranged opposite to each other, as well as a first lateral side-frame 122 and a second lateral side-frame 124 each connected between the top side-frame 121 and the bottom side-frame 123. The first lateral side-frame 122 and the second lateral side-frame 124 are arranged opposite to each other. The top side-frame 121, the first lateral side-frame 122, the bottom side-frame 123, and the second lateral side-frame 124 are connected end to end in sequence and located on the outer periphery of the middle plate. Specifically, the connections between individual side-frame may be in a form of right-angle connection or arc transition connection. Further, when the frame 120 is a metal frame, multiple metal frame antennas may be provided in the frame 120. Specifically, the metal frame antennas may be provided by arranging gaps in the frame 120.

The back cover is connected to the frame 120 to define an accommodating cavity, that is, an installation space, for installing electronic components of the electronic device such as a battery, a main board, and a camera module. The main board may be a printed circuit board (PCB) or a flexible printed circuit (FPC). The main board may integrate electronic components of the electronic device such as a processor, a storage unit, a power management module, a baseband chip, a camera, a sensor, and a receiver.

The electronic device further includes a ground plane (ground plate). Optionally, the frame 120 is arranged around the ground plane. It is understandable that the ground plane is arranged in the accommodating space defined by the frame 120. The shape of the ground plane is roughly rectangular. Various slots, holes, etc. are provided on the reference ground edge of the ground plane, according to requirements of device arrangements or avoidance of other structures in the mobile phone. The ground plane may serve as a common ground of the electronic device 100, and the ground plane may be a plane or structure with a potential of zero. Exemplarily, the ground plane may be formed by conductors, printed wiring, or a metal printed layer in the electronic device. Alternatively, the ground plane may be formed on the main board, a sub-board, or other bearing boards of the electronic device 100. Alternatively, the ground plane may be a part of the middle frame (also referred to as the middle plate) of the electronic device 100. It is notable that the above are several examples of the ground plane, and should not be understood as limiting the ground plane provided by the embodiments of the present disclosure.

The specific structures of the antenna assembly and the electronic device will be illustrated below with reference to the accompanying drawings.

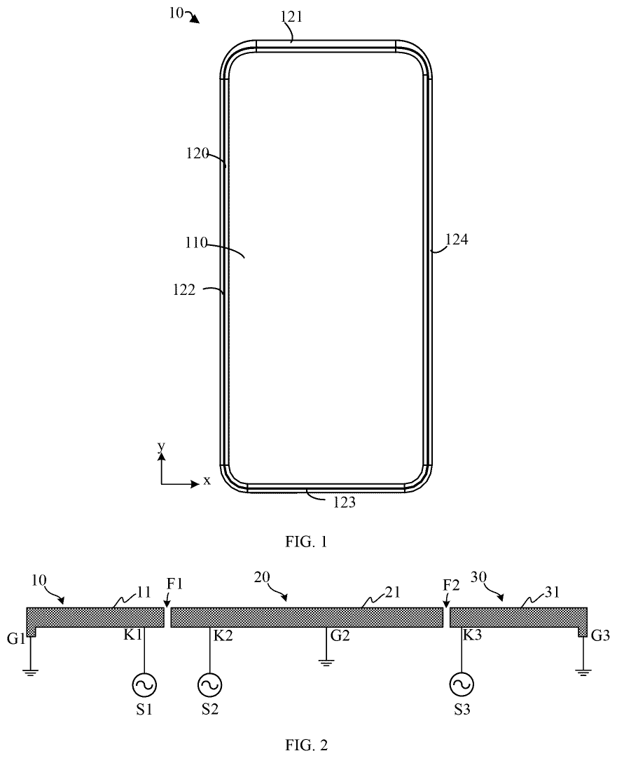

FIG. 2 is a diagram illustrating the structure of an antenna assembly according to an embodiment. Referring to FIG. 2, in this embodiment, the antenna assembly includes a first antenna 10, a second antenna 20, and a third antenna 30. The first antenna 10 includes a first radiator 11 and a first feed source S1. The first feed source S1 is connected to a first feed point K1 of the first radiator 11, to excite the first radiator 11 to support a first frequency band and a second frequency band. It can be understood that a first excitation signal provided by the first feed source S1 is fed to the first feed point K1 to excite the first radiator 11 to generate multiple resonance modes to support the first frequency band and the second frequency band. The center frequency of the first frequency band is different from the center frequency of the second frequency band, and the center frequency of the first frequency band is lower than that of the second frequency band. Both the first frequency band and the second frequency band are cellular standard frequency bands, for example, they may be 4G LTE frequency bands or 5G NR frequency bands. Exemplarily, the first frequency band may be a low-frequency band, for example, it may be a low-frequency band of 4G LTE such as B28, B5, or B8, or it may also be a corresponding low-frequency band of 5G NR such as N28, N5, or N8; and the second frequency band may be an ultra-high frequency band, such as N77, N78, or N79 frequency band.

The second antenna 20 includes a second radiator 21 and a second feed source S2. There is a first gap F1 between a first terminal of the second radiator 21 and the first radiator 11, and the second radiator 21 is capacitively coupled with the first radiator 11 through the first gap F1. Capacitive coupling means that an electric field is generated between the first radiator 11 and the second radiator 21, the signal of the first radiator 11 can be transmitted to the second radiator 21 through the electric field, and the signal of the second radiator 21 can be transmitted to the first radiator 11 through the electric field, so that electrical signals can be transmitted between the first radiator 11 and the second radiator 21 even through the two radiators are in a disconnected state. The second radiator 21 is provided with a second feed point K2 and a ground strap point G2, and the second feed point K2 is spaced apart from the ground strap point G2. The ground strap point means a point or area where a ground strap is connected. The second feed point K2 is arranged close to the first gap F1, and the ground strap point G2 is connected to a common ground terminal. In the embodiments of the present disclosure, the common ground terminal may be a ground plane of the electronic device. The second feed source S2 is connected to the second feed point K2 to excite the first radiator 11 to support a third frequency band and a fourth frequency band, and to excite the first radiator 11 and the second radiator 21 to jointly support the third frequency band and the fourth frequency band. It can be understood that a second excitation signal provided by the second feed source S2 is fed to the second feed point K2 to excite the second radiator 21 to generate multiple resonance modes to support the third frequency band and the fourth frequency band. In addition, the signal on the second radiator 21 can be capacitively coupled to the first radiator 11 through the first gap F1, so that the first radiator 11 and the second radiator 21 can jointly support the third frequency band and the fourth frequency band.

The standard of the third frequency band is different from the standard of the fourth frequency band. Exemplarily, the third frequency band may be a cellular standard frequency band, for example, it may be a frequency band of cellular standard such as 4G LTE or 5G NR frequency band; and the fourth frequency band may be a 2.4 G frequency band of the WiFi standard or Bluetooth BT standard. The frequency range of the third frequency band and the frequency range of the fourth frequency band may be within a same preset range, for example, 1.71 GHz-2.7 GHZ. Exemplarily, the third frequency band may include medium-high frequency bands of LTE or medium-high frequency bands of NR, for example, it may be any of medium high-frequency bands of 4G LET such as B1, B2, B3, B7, B40 or B41, or it may also be any of corresponding medium-high frequency bands of 5G NR such as N1, N2, N3, N7, N40, or N41.

The third antenna 30 includes a third radiator 31 and a third feed source S3. There is a second gap F2 between the third radiator 31 and a second terminal of the second radiator 21, and the third radiator 31 is coupled with the second radiator 21 through the second gap F2. The third feed source S3 is connected to a third feed point K3 of the third radiator 31 to excite the third radiator 31 and a part of the second radiator 21 to support a second frequency band and a WiFi 5G frequency band. An electric field is generated between the second radiator 21 and the third radiator 31, the signal of the second radiator 21 can be transmitted to the third radiator 31 through the electric field, and the signal of the third radiator 31 can be transmitted to the second radiator 21 through the electric field, so that electrical signals can be transmitted between the second radiator 21 and the third radiator 31 even through the two radiators are in a disconnected state. It can be understood that a third excitation signal provided by the third feed source S3 is fed to the third feed point K3, and makes the third radiator 31 be capacitively coupled with the second radiator 21 through the second gap F2, to excite the third radiator 31 and a part of the second radiator 21 to generate multiple resonance modes to support the second frequency band and the WiFi 5G frequency band. Exemplarily, the second frequency band may include an ultra-high frequency band, such as N77, N78, or N79 frequency band. In the embodiments of the present disclosure, the second frequency band supported by the first antenna 10 and the second frequency band supported by the third antenna 30 are both ultra-high frequency bands, but the specific sub-bands (e.g., N77, N78, or N79 frequency band) they support may be the same or different. Exemplarily, the sub-band supported by the first antenna 10 may be the N79 frequency band, and the sub-band supported by the third antenna 30 may be the N78 frequency band. Optionally, the sub-band supported by the first antenna 10 and the sub-bands supported by the third antenna 30 are the same, such as N77, N78, or N79 frequency band, so as to realize dual transmission or dual reception of the ultra-high frequency band, thereby improving the throughput of the ultra-high frequency band and improving the communication performance of the ultra-high frequency band.

The widths of the first gap F1 and the second gap F2 can meet the boundary condition for capacitive coupling of two radiators. Exemplarily, the width of each of the first gap F1 and the second gap F2 may be less than or equal to 5 mm. Optionally, the first gap F1 and the second gap F2 may be filled with for example an insulating dielectric material, to improve the structural strength of the frame 120 of the antenna assembly.

Optionally, the first feed source S1, the second feed source S2, and the third feed source S3 may be arranged on the main board of the electronic device. The first feed source S1, the second feed source S2, and the third feed source S3 may be three independent feed sources, which can independently provide corresponding feed signals.

Optionally, each of the first radiator 11, the second radiator 21, and the third radiator 31 may be one of a flexible printed circuit (FPC) antenna radiator, a laser direct structuring (LDS) antenna radiator, a print direct structuring (PDS) antenna radiator, and a metal radiating branch. In the embodiments of the present disclosure, the types of the first radiator 11, the second radiator 21, and the third radiator 31 are not further limited, and the types of the first radiator 11, the second radiator 21, and the third radiator 31 may be the same or different. In the embodiments of the present disclosure, the shapes of the first radiator 11, the second radiator 21, and the third radiator 31 may be strip-shaped, bent-shaped, curved-shaped, etc. In the embodiments of the present disclosure, the shapes of the first radiator 11, the second radiator 21, and the third radiator 31 are not limited.

The above antenna assembly includes the first antenna 10, the second antenna 20, and the third antenna 30. The first antenna 10, the second antenna 20, and the third antenna 30 are arranged in a face-to-face (or boresight-to-boresight), back-to-back, or aperture sharing configuration, which can support the first frequency band, the second frequency band, and the third frequency band of the cellular standard, as well as WiFi 2.4G (or Bluetooth 2.4G) and WiFi 5G. They can realize full-band coverage of the cellular standard and the WiFi standard, expand the coverage frequency bands of the antenna assembly, and realize CA (Carrier Aggregation) combinations, DSDA (Dual Sim Dual Active) combinations, ENDC (E-UTRAN New Radio-Dual Connectivity) combinations, etc., such as LB+MHB, LB+N41/N78/N79, MHB+N41/N78/N79 under the cellular standard. In addition, they can also realize the coexistence of any frequency band under the cellular standard (e.g., low frequency, medium-high frequency, or ultra-high frequency) and the WiFi standard (WiFi 2.4G/WiFi 5G) for simultaneous communication, which can improve the throughput of the antenna assembly and thus improve the communication performance of the antenna assembly.

In addition, different from the related art in which multiple independent antenna modules are used to cover the above frequency bands, in the antenna assembly provided by the present disclosure, any antenna can support two frequency bands, and only three radiators are provided to realize the full-band coverage of the cellular standard and the WiFi standard, where the second radiator 21 can be capacitively coupled with each of the first radiator 11 and the second radiator 21. This greatly simplifies the structure of the antenna assembly, improves the integration degree of the antenna assembly, reduces the overall volume of the antenna assembly, and is conducive to improving the overall miniaturization design of the electronic device equipped with the antenna assembly.

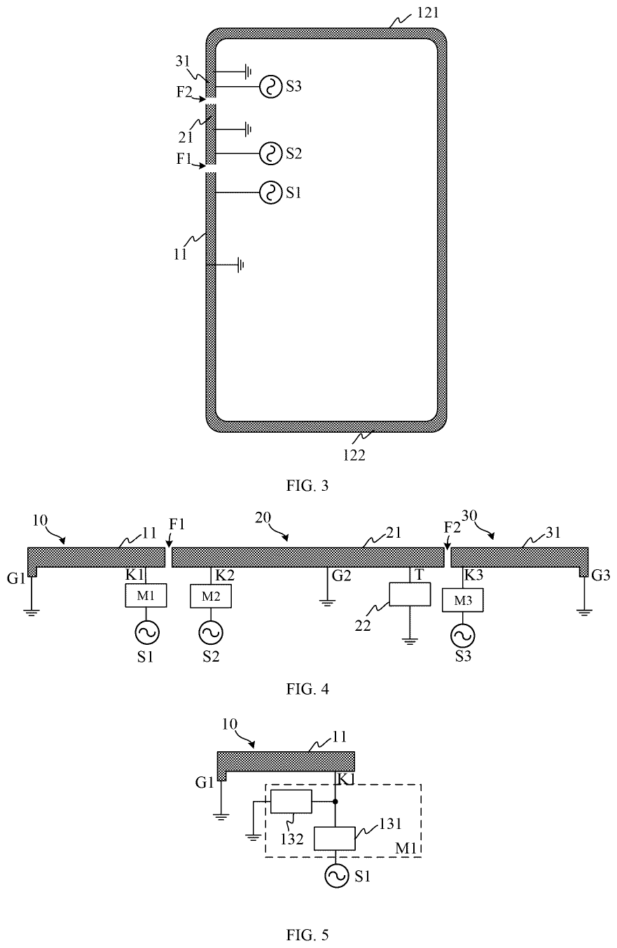

In the embodiments of the present disclosure, for convenience of description, as illustrated in FIG. 3, the specific structures of the first antenna, the second antenna, and the third antenna are described by taking a case where the first radiator 11, the second radiator 21, and the third radiator 31 are metal radiating branches (e.g., conductive side-frames of the electronic device) as an example. The first radiator 11, the second radiator 21, and the third radiator 31 are all located on a same lateral side-frame of the electronic device, and the extending directions of the first radiator 11, the second radiator 21, and the third radiator 31 are the same as the extending direction of the lateral side-frame.

As illustrated in FIG. 4, in an exemplary embodiment, the first antenna 10 further includes a first matching circuit M1. A first terminal of the first matching circuit M1 is connected to the first feed source S1, and a second terminal of the first matching circuit M1 is connected to the first feed point K1. The first excitation signal provided by the first feed source S1, after undergoing impedance matching by the first matching circuit M1, may excite the first radiator 11 to generate a first resonance mode to support a low-frequency band, and excite the first radiator 11 to generate a second resonance mode to support an ultra-high frequency band.

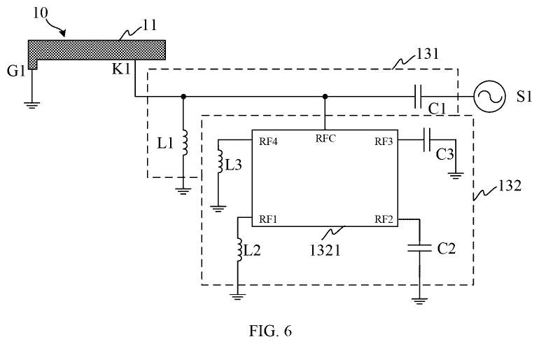

As illustrated in FIG. 5, the first matching circuit M1 includes at least a first matching unit 131. A first terminal of the first matching unit 131 is connected to the first feed source S1, and a second terminal of the first matching unit 131 is connected to the first feed point K1. Exemplarily, as illustrated in FIG. 6, the first matching unit 131 may include at least a first capacitor C1, a first terminal of the first capacitor C1 is the first terminal of the first matching unit 131, and a second terminal of the first capacitor C1 is the second terminal of the first matching unit 131. Optionally, the first matching unit 131 may further include a first inductor L1, a first terminal of the first inductor L1 is connected to each of the first feed point K1 and the second terminal of the first capacitor C1, and a second terminal of the first inductor L1 is connected to the common ground terminal.

The first radiator 11 is further provided with a first ground point G1 connected to the common ground terminal, and the first ground point G1 is arranged away from the first gap F1. It can be understood that the first feed point K1 is arranged between the first ground point G1 and the first gap F1. The first resonance mode includes an IFA (Inverted-F antenna) quarter-wavelength mode of a part of the first radiator from the first gap F1 to the first ground point G1. The primary mode of the first resonance mode is excited by the first capacitor C1 in the first matching circuit M1.

Optionally, referring to FIG. 5, the first matching circuit M1 further includes a first tuning unit 132, and the first tuning unit 132 is connected to each of the second terminal of the first matching unit 131, the first feed point K1, and the common ground terminal, and is used to adjust the equivalent electrical length of the first radiator 11. Different tuning parameters of the first tuning unit 132 correspond to different equivalent electrical lengths of the first radiator 11 and thus different resonance frequencies of the first resonance mode, that is, different center frequencies of the first frequency band. The first tuning unit 132 may include tuning devices such as capacitors and inductors, and the capacitance of the capacitors and the inductance of the inductors may be the tuning parameters of the first tuning unit 132.

In this embodiment, the equivalent electrical length of the first radiator 11 may be adjusted through the first tuning unit 132, and then the center frequency of the first frequency band may be adjusted. In the embodiments of the present disclosure, it is illustrated by taking a case where the first frequency band is a low-frequency band as an example. When the tuning parameter(s) of the first tuning unit 132 is adjusted, it may support a low-frequency band such as B28 (or N28), B5 (or N5), or B8 (or N8), so as to support switching among different low-frequency bands.

In an exemplary embodiment, referring to FIG. 6, the first tuning unit 132 includes a tuning switch 1321 and multiple tuning devices. A common terminal of the tuning switch 1321 is connected to each of the first matching unit 131 and the first feed point K1, and each selection terminal of the tuning switch 1321 is connected to a first terminal of one corresponding tuning device, and a second terminal of each tuning device is connected to the common ground terminal. Exemplarily, the tuning switch 1321 may be a single-pole four-throw switch, such as an SP4T switch, which may include a common terminal RFC and four selection terminals. The common terminal RFC of the tuning switch 1321 may be connected to each of the first matching unit 131 and the first feed point K1, that is, the common terminal RFC of the tuning switch 1321 may be connected to each of the second terminal of the first capacitor C1 and the first terminal of the first inductor L1. Each selection terminal of the tuning switch 1321 is connected to the common ground terminal through a corresponding tuning device. The tuning device may include a capacitor or an inductor. The first tuning unit 132 may include four tuning devices, such as a second capacitor C2, a third capacitor C3, a second inductor L2, and a third inductor L3. The capacitance of the second capacitor C2 is different from the capacitance of the third capacitor C3, and the inductance of the second inductor L2 is different from the inductance of the third inductor L3. For example, the first selection terminal RF1 of the tuning switch 1321 is connected to the second inductor L2, the second selection terminal RF2 of the tuning switch 1321 is connected to the second capacitor C2, the third selection terminal RF3 of the tuning switch 1321 is connected to the third capacitor C3, and the fourth selection terminal RF4 of the tuning switch 1321 is connected to the third inductor L3.

When the tuning switch 1321 makes the common terminal RFC conductively connected to different selection terminals, the tuning parameters of the first tuning unit 132 are different, and the resonance frequencies of the first resonance mode are different. Exemplarily, when the tuning switch 1321 switches on a path between the common terminal RFC and the first selection terminal RF1, the first antenna 10 may support the B28 frequency band; when the tuning switch 1321 switches on a path between the common terminal RFC and the third selection terminal RF3, the first antenna 10 may support the B5 frequency band; and when the tuning switch 1321 switches on a path between the common terminal RFC and the fourth selection terminal RF4, the first antenna 10 may support the B8 frequency band.

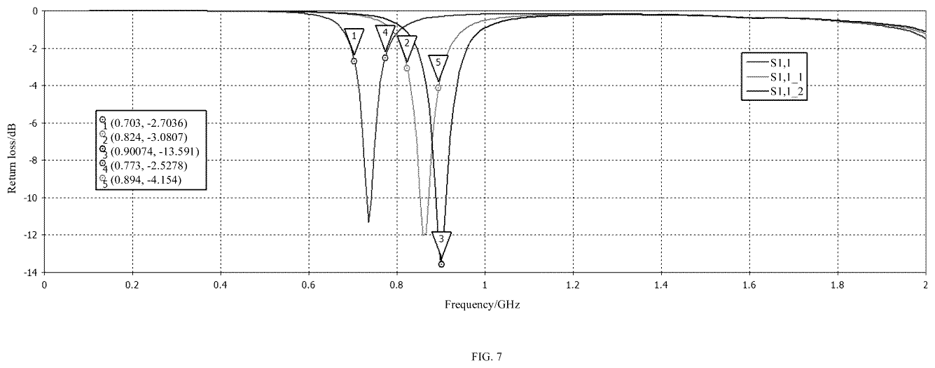

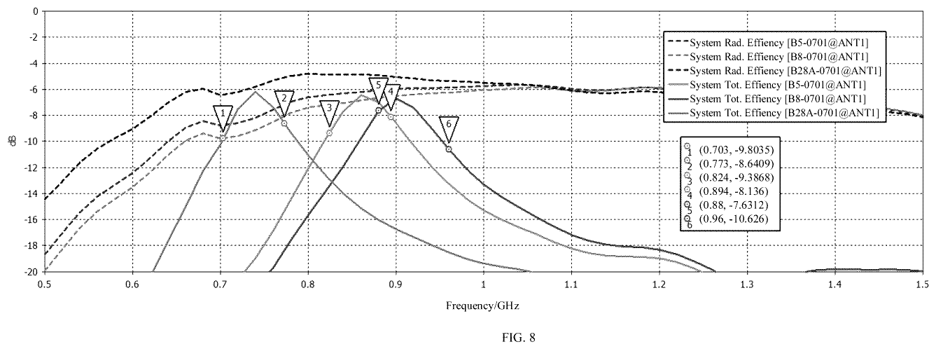

In this embodiment, by means of provision of the first tuning unit 132, switching may be performed among different tuning devices through the tuning switch 1321, to adjust the equivalent electrical length of the first radiator 11, and then adjust the resonance frequency of the first resonance mode, so as to support switching among multiple different sub-bands, for example, switching among frequency bands such as B28, B5, and B8 may be enabled. The return loss of the first antenna in a free scenario is shown in FIG. 7. The antenna efficiency of the first antenna in the free scenario is shown in FIG. 8. The free scenario refers to a scenario where each radiator of the antenna assembly is not blocked and can radiate freely. It can be seen from FIG. 8 that the average efficiency of the first antenna 10 in supporting B28, B5, and B8 is within-7.5 dB, and the first antenna 10 can well meet the requirement of being used as a low-frequency transmitting antenna. When the antenna assembly is applied to/implemented in an electronic device, the first antenna 10 may be used as a low-frequency transmitting antenna or a low-frequency diversity receiving antenna of the electronic device.

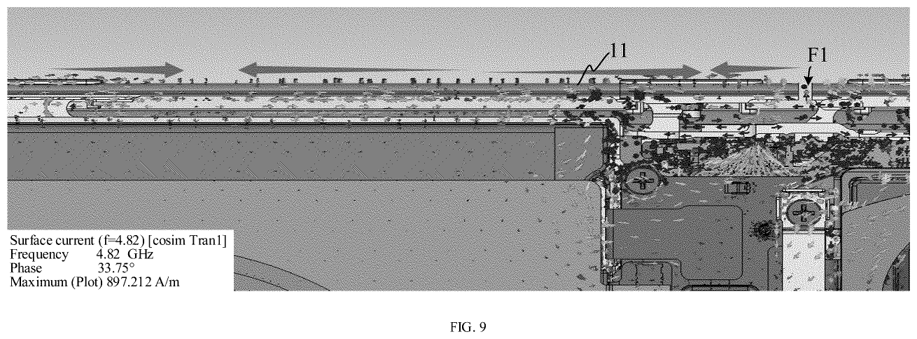

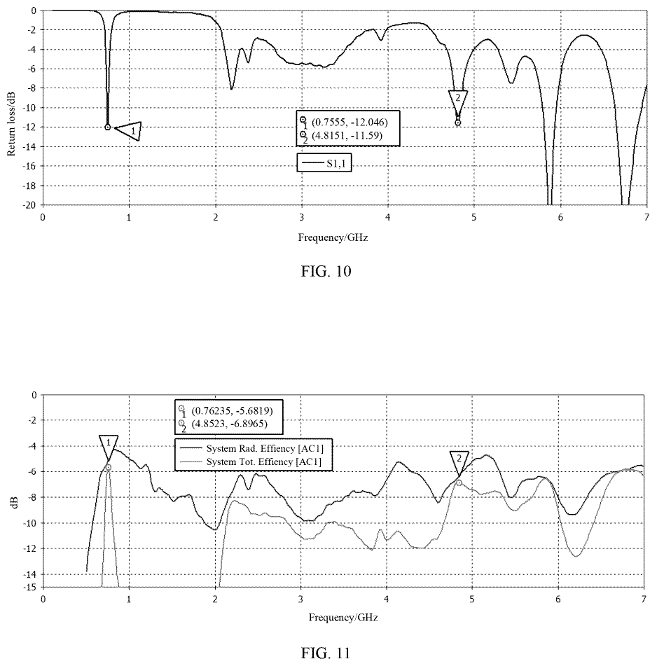

The second resonance mode includes an IFA seven-quarter-wavelength mode of a part of the first radiator from the first gap F1 to the first ground point G1. The primary mode of the second resonance mode may also be excited by the first capacitor C1 in the first matching circuit M1. In the embodiments of the present disclosure, it is illustrated by taking a case where the second frequency band is an ultra-high frequency band such as the N79 frequency band as an example. The current distribution corresponding to the second resonance mode is shown in FIG. 9. The return loss of the first antenna in the free scenario is shown in FIG. 10. The antenna efficiency of the first antenna in supporting the second frequency band in the free scenario is shown in FIG. 11. It can be seen from FIG. 11 that the antenna efficiency of the first antenna 10 in supporting the second frequency band is within −7.5 dB, which can well meet the requirement of being used as an N79 transmitting antenna. When the antenna assembly is applied to the electronic device, the first antenna 10 may be used as an ultra-high frequency primary antenna of the electronic device.

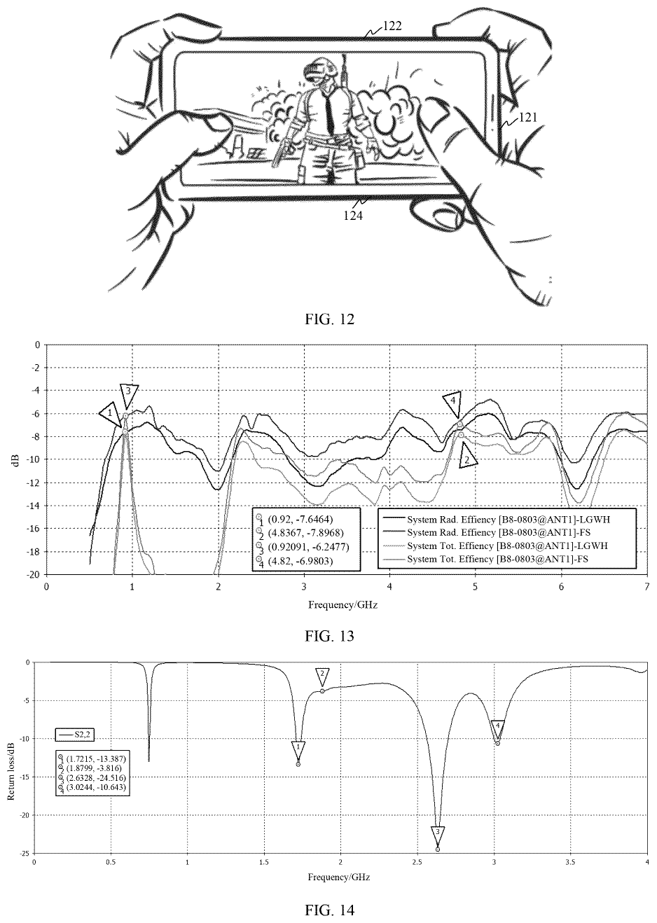

When the antenna assembly in the above embodiment is applied to the electronic device, the placement position of the first radiator 11 of the first antenna 10 in the electronic device, the length of the first radiator 11, and the position of the first feed point K1 may be set; and as illustrated in FIG. 3, the first radiator 11 is located on the lateral side-frame of the electronic device. Through characteristic simulation technology, it is obtained that the aperture of the first antenna 10 faces upward, and the first gap F1 between the first antenna 10 and the second antenna 20 is centered (i.e., at the waist position of the left side-frame). In a landscape holding state (i.e., a state in which the electronic device is hold in landscape mode), as illustrated in FIG. 12, the first radiator 11 of the first antenna 10 cannot be held. That is, in the landscape holding state, the first radiator 11 of the first antenna 10 is not blocked. In the embodiments of the present disclosure, the landscape holding state may correspond to a game scenario.

The efficiencies of the first antenna respectively in the free state and the landscape holding state (e.g., landscape gaming with hand (LGWH), which may means a state in which a mobile game is played in landscape mode with hand) are shown in FIG. 13. It can be seen from FIG. 13 that, in the free state, the efficiencies of the first antenna at 0.92 GHz and 4.82 G are −6.2 dB and −6.98 dB respectively; and in the landscape holding state, the efficiencies of the first antenna at 0.92 GHz and 4.82 G are −7.6 dB and −7.89 dB respectively. It can be seen that, at 0.92 GHz and 4.82 GHz, the efficiency degradation of the first antenna 10 in the landscape holding state are 1.4 dB and 0.9 dB respectively. The efficiencies of the first antenna in supporting B28, B5, B8, and N79 frequency bands respectively in the free state and the landscape holding state are shown in Table 1.

TABLE 1
Efficiencies of the first antenna in supporting B28, B5, B8, and N79
respectively in the free state and the landscape holding state

| | | | | Efficiency in | |
|---|---|---|---|---|---|
| | Frequency | Conductive | Efficiency in | Landscape | Efficiency |
| | Band | State | Free State | Holding State | Degradation |
| First | B28A | ALL OFF | −6.8 | −7.7 | 0.9 |
| Antenna | B5 | RF3 | −6.9 | −8.2 | 1.3 |
| | B8 | RF4 | −7.4 | −8.8 | 1.4 |
| | N79 | ALL OFF | −6.9 | −7.8 | 0.9 |

It is notable that the conductive state in Table 1 indicates the conductive state of the tuning switch 1321. ALL OFF indicates that the tuning switch 1321 does not work, and each selection terminal is not conductively connected to the common terminal RFC. RF3 in the table indicates that the common terminal RFC is conductively connected to the third selection terminal, and RF4 in the table indicates that the common terminal RFC is conductively connected to the fourth selection terminal.

It can be seen from Table 1 that the efficiency degradation of the first antenna 10 in supporting B28, B5, B8, and N79 frequency bands in the landscape holding state is all within 1.5 dB.

In addition, compared with the related art (in which one low-frequency transmitting antenna is provided at the bottom of the electronic device, and one low-frequency transmitting antenna is provided at the right side of the electronic device, and the low-frequency degradation in landscape holding state is 7 dB-9 dB), in the antenna assembly provided by the embodiments of the present disclosure, the efficiency degradation of the first antenna 10 in supporting low-frequency bands in the landscape holding state is reduced by 5.5 dB-7.5 dB, which can greatly improve the efficiency of radiating low-frequency signals, improve the communication performance in weak signal areas (e.g., areas that are far away from the city center, deployed with more low-frequency base stations, and have low population density), and thus improve the gaming experience. In addition, the antenna assembly can realize full-band and full-standard transmitting antenna coverage such as LMHB/NR/WIFI 2.4G/WIFI 5G, realize CA combinations or DSDA combinations such as LB+MHB, LB+N41/N78/N79, or MHB+N41/N78/N79, and realize the coexistence of cellular standard and WIFI such as LB+WIFI 2.4G/WIFI 5G, MHB+WIFI 2.4G/WIFI 5G, N28/N5/N8/N41/N78/N79+WIFI 2.4G/WIFI 5G, so as to improve the communication quality of the antenna assembly.

In an exemplary embodiment, the second feed point K2 is arranged close to the first gap F1, and a tuning point is arranged close to the second gap F2. It is understandable that the ground strap point G2 is located in the middle part of the second radiator 21. Referring to FIG. 4, the second antenna 20 further includes a second matching circuit M2. A first terminal of the second matching circuit M2 is connected to the second feed source S2, and a second terminal of the second matching circuit M2 is connected to the second feed point K2. The second feed signal provided by the second feed source S2, after undergoing impedance matching by the second matching circuit M2, may be fed into the second radiator 21 through the second feed point K2, to excite the second radiator 21 to generate multiple resonance modes to support the third frequency band and the fourth frequency band. In addition, the second feed signal may also be coupled to the first radiator 11 through the first gap F1, so that the first radiator 11 and the second radiator 21 may jointly generate multiple resonance modes to support the third frequency band and the fourth frequency band. The return loss of the second antenna is shown in FIG. 14. The second antenna 20 may generate four resonance modes, such as a third resonance mode, a fourth resonance mode, a fifth resonance mode, and a sixth resonance mode, realizing ultra-wideband coverage from 1.71 GHz-2.7 GHZ. Under the excitation of the second feed signal provided by the second feed source S2, the second radiator 21 is excited to generate the third resonance mode and the fifth resonance mode to support the third frequency band and the fourth frequency band, and the first radiator 11 and the second radiator 21 are excited to generate the fourth resonance mode and the sixth resonance mode to support the third frequency band and the fourth frequency band. In the embodiments of the present disclosure, it is illustrated by taking a case where the third frequency band is a medium-high frequency band of LTE or NR and the fourth frequency band is the WiFi 2.4G frequency band as an example.

In an exemplary embodiment, the second matching circuit M2 may also be used to adjust the resonance frequency of the third resonance mode, so that the resonance frequency thereof may be shifted to expand the bandwidth of the third frequency band.

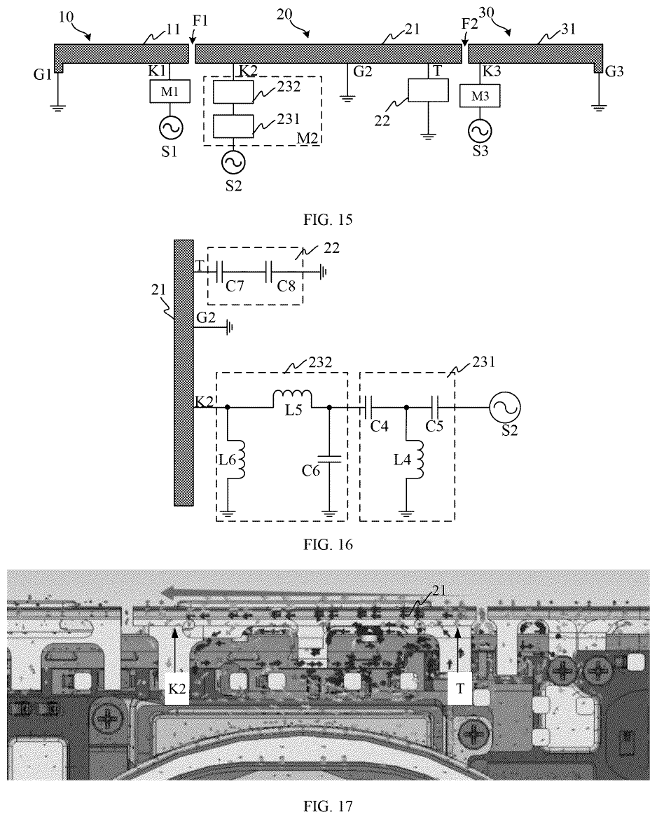

In an exemplary embodiment, as illustrated in FIG. 15, the second matching circuit M2 may include a second matching unit 231 and a second tuning unit 232. The second feed signal provided by the second feed source S2, after undergoing impedance matching by the second matching unit 231, may excite the second radiator 21, or excite the second radiator 21 and the first radiator 11 to to jointly generate multiple resonance modes, to support the third frequency band and the fourth frequency band. Optionally, as illustrated in FIG. 16, the second matching unit 231 may include at least a fourth capacitor C4. A first terminal of the fourth capacitor C4 is connected to the second feed source S2, and a second terminal of the fourth capacitor C4 is connected to the second feed point K2. The aforementioned third resonance mode, fourth resonance mode, fifth resonance mode, and sixth resonance mode may all be excited by the fourth capacitor C4.

Optionally, referring to FIG. 16, the second matching unit 231 may further include a fifth capacitor C5 and a fourth inductor L4. A first terminal of the fifth capacitor C5 is connected to the second feed source S2, a second terminal of the fifth capacitor C5 is connected to a second terminal of the fourth capacitor C4, a first terminal of the fourth capacitor C4 is connected to the second tuning unit 232, a first terminal of the fourth inductor L4 is connected to the second terminal of the fifth capacitor C5, and a second terminal of the fourth inductor L4 is connected to the common ground terminal. It is notable that the second matching unit 231 may also be in other forms of matching networks for impedance matching, and it is not limited to the foregoing examples.

Referring to FIG. 4 and FIG. 15, the second antenna 20 further includes a tuning circuit 22. A first terminal of the tuning circuit 22 is connected to the common ground terminal, and a second terminal of the tuning circuit 22 is connected to the tuning point T. The ground strap point G2 is arranged between the second feed point K2 and the tuning point T. The tuning circuit 22 is used for the resonance frequency of the third resonance mode and the center frequency of the third frequency band, and it may make the center frequency of the third frequency band shifted.

Referring to FIG. 16, the second tuning unit 232 may include a sixth capacitor C6, a fifth inductor L5, and a sixth inductor L6. A first terminal of the sixth capacitor C6 is connected to the first terminal of the fourth capacitor C4 and a first terminal of the fifth inductor L5, a second terminal of the sixth capacitor C6 is connected to the common ground terminal, a first terminal of the fourth inductor L4 is connected to each of the second feed point and a second terminal of the fifth inductor L5, and a second terminal of the fourth inductor L4 is connected to the common ground terminal. Optionally, the second tuning unit 232 includes, but is not limited to, multiple tuning devices arranged in series and/or parallel, and the tuning devices may include capacitors, inductors, resistors, or the like. In the embodiments of the present disclosure, the types, quantities, and connection relationships of the tuning devices included in the second tuning unit 232 are not further limited.

The resonance modes of the second antenna 20 will be exemplarily described below with reference to the accompanying drawings based on the first matching circuit M1, the second matching circuit M2, and the tuning circuit 22.

The second antenna 20 may generate a third resonance mode. As illustrated in FIG. 17, the third resonance mode includes a balanced mode of a part of the second radiator from the tuning point T to the second feed point K2. The equivalent electrical length of the corresponding radiator in the third resonance mode may be controlled by the tuning parameters of the tuning circuit. By adjusting the tuning parameters of the tuning circuit, the resonance frequency of the third resonance mode (that is, the center frequency of the third frequency band) may be adjusted to any position between 1.71 GHz and 2.7 GHZ, that is, any frequency between the B3 frequency band and the B41 frequency band. The adjustable frequencies include 1.71 GHz and 2.7 GHZ, and the adjustable frequency bands include the B3 frequency band and the B41 frequency band.

Referring to FIG. 16, the tuning circuit 22 includes a first tuning capacitor C7 and a second tuning capacitor C8. A first terminal of the first tuning capacitor C7 is connected to the tuning point T, a second terminal of the first tuning capacitor C7 is connected to a first terminal of the second tuning capacitor C8, and a second terminal of the second tuning capacitor C8 is connected to the common ground terminal. Exemplarily, in the third resonance mode, the equivalent electrical length of the corresponding radiator may be controlled by the first tuning capacitor C7 and the second tuning capacitor C8 in the tuning circuit. By adjusting the capacitance of the first tuning capacitor C7 and the capacitance of the second tuning capacitor C8, any frequency band between B3 and B41 may be switched to, for example, any frequency band among B3, B1, B40, and B41 may be switched to. The tuning circuit has strong adjustability, realizing switching of the second antenna 20 to any medium-high frequency band, thereby improving the communication performance of the antenna assembly.

In an exemplary embodiment, the width of a part of the second radiator where the ground strap point G2 is located ranges from 1.5 mm to 2.5 mm, and it has a certain distance from the ground plane. Exemplarily, the width of the part of the second radiator where the ground strap point G2 is located may be 1.5 mm, 1.8 mm, 2 mm, 2.2 mm, or 2.5 mm, etc. By setting the width of the part of the second radiator where the ground strap point G2 is located, it can avoid a situation that a too wide area where the ground strap point G2 is located would cause the current from the tuning point T to directly flow back to the ground terminal through the ground strap point G2 without flowing to the second feed point K2, in the third resonance mode.

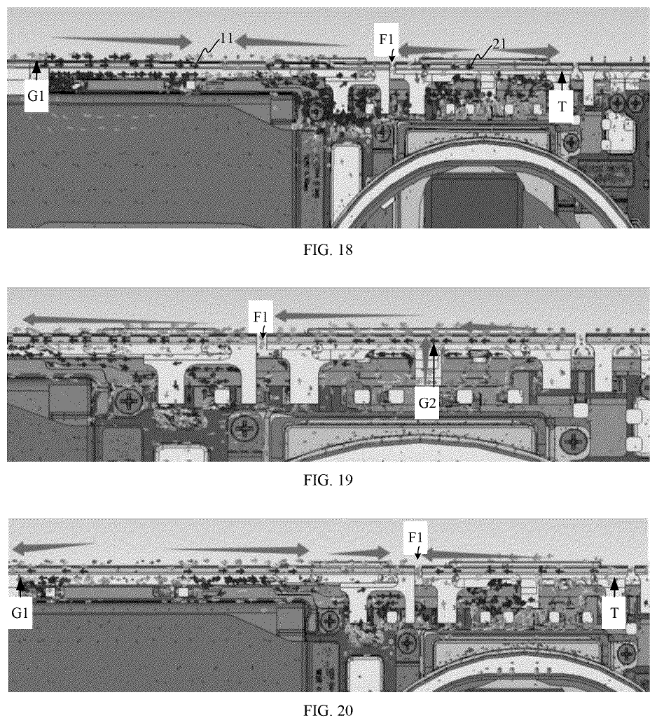

The second antenna may generate the fourth resonance mode. As illustrated in FIG. 18, the fourth resonance mode includes an RM mode of a part of the second radiator from the first gap F1 to the tuning point T, and a three-quarter-wavelength mode of a part of the first radiator from the first ground point G1 to the first gap F1.

The equivalent electrical length of the corresponding radiator in the fourth resonance mode may be controlled by the tuning parameters of the first tuning unit 132 in the first matching circuit M1. By adjusting the tuning parameters of the first tuning unit 132, the resonance frequency of the fourth resonance mode (that is, the center frequency of the third frequency band) may be adjusted to any position between 1.71 GHz and 2.7 GHZ, that is, any frequency between the B3 frequency band and the B41 frequency band. For example, the equivalent electrical length corresponding to the fourth resonance mode is mainly controlled by the second capacitor C2 of the first tuning unit 132. The tuning switch 1321 may be switched to the second selection terminal RF2 to adjust the capacitance of the second capacitor C2, so that the resonance position may be adjusted to any position between B3 and B41, and any frequency band between B3 to B41 can be switched to. The tuning circuit has strong adjustability, realizing switching of the second antenna 20 to any medium-high frequency band, thereby improving the communication performance of the antenna assembly.

The second antenna may generate a fifth resonance mode. As illustrated in FIG. 19, the fifth resonance mode includes an IFA quarter-wavelength mode of a part of the second radiator from the first gap F1 to the ground strap point G2.

The equivalent electrical length of the corresponding radiator in the fifth resonance mode may be controlled by the tuning parameters of the second tuning unit 232. By adjusting the tuning parameters of the second tuning unit 232, the resonance frequency of the fifth resonance mode (that is, the center frequency of the third frequency band) may be adjusted to any position between 1.71 GHz and 2.7 GHZ, that is, any frequency between the B3 frequency band and the B41 frequency band. For example, the equivalent electrical length corresponding to the fifth resonance mode is mainly controlled by the fifth inductor L5 and the sixth capacitor C6 of the second tuning unit 232. By adjusting the inductance of the fifth inductor L5 and the capacitance of the sixth capacitor C6, the resonance position may be adjusted to any position between B3 and B41, and any frequency band between B3 to B41 may be switched to. The tuning circuit has strong adjustability, realizing switching of the second antenna 20 to any medium-high frequency band, thereby improving the communication performance of the antenna assembly.

The second antenna may generate the sixth resonance mode. As illustrated in FIG. 20, the sixth resonance mode includes an RM mode of a part of the second radiator from the tuning point T to the first gap F1, and a three-quarter-wavelength mode of a part of the first radiator from the first gap F1 to the first ground point G1. As shown in FIG. 18 and FIG. 20, a flowing direction of current in the fourth resonance mode is different from a flowing direction of current in the sixth resonance mode.

The equivalent electrical length of the corresponding radiator in the sixth resonance mode may be controlled by the tuning parameters in the first tuning unit 132, for example, it is controlled by the capacitance of the second capacitor C2. Exemplarily, the tuning switch 1321 may be switched to make the second selection terminal RF2 conductively connected, and the capacitance of the second capacitor C2 may be adjusted to adjust the resonance frequency of the sixth resonance mode (that is, the center frequency of the third frequency band) to any position between 2.9 GHz and 3.5 GHZ, which can enhance the B41, broaden the bandwidth of B41, and improve the efficiency of B41.

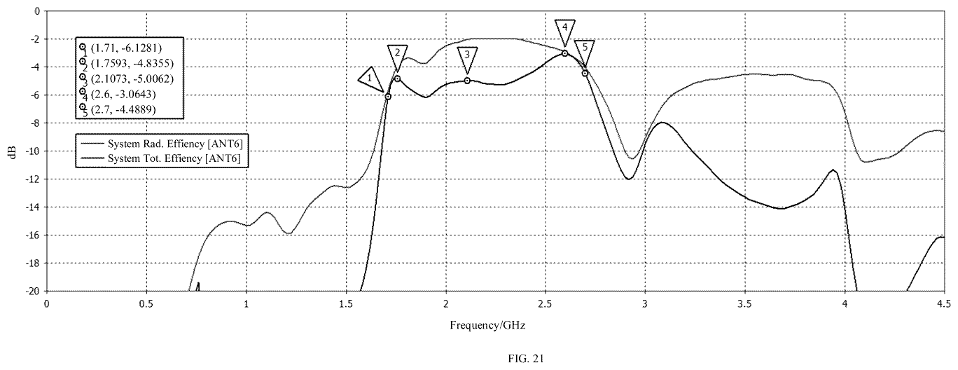

FIG. 21 is a diagram of simulated efficiency waveforms of the second antenna in supporting the third frequency band and the fourth frequency band. It can be seen from FIG. 21 that the average efficiency of the second antenna is within −6 dB, and the efficiencies at WIFI 2.4G and B41 are −4.3 dB and −3.8 dB respectively. It can be seen that the second antenna 20 does not need to be additionally provided with a tuning switch 1321, and it may reuse the tuning switch 1321 of the first antenna 10 with low cost. In this case, high antenna efficiency can still be maintained, the communication performance is good, and the user's gaming experience can also be improved. When the antenna assembly is applied to the electronic device, the second antenna 20 may be used as a medium-high frequency primary antenna (or medium-high frequency primary MIMO antenna), an N41 primary antenna, an N40 primary antenna, an N1/3/7 primary MIMO antenna, a WiFi 2.4G antenna, or a Bluetooth antenna of the electronic device.

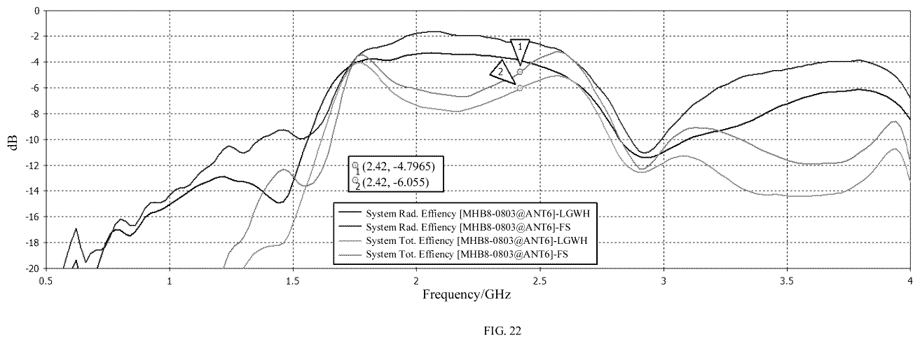

In the landscape holding state (e.g., in the game scenario), the radiator of the second antenna 20 is located at the waist and cannot be held by both hands. The efficiency of the second antenna is shown in FIG. 22. It can be seen from FIG. 22 that, in the free state, the efficiency of the second antenna at 2.42 GHz is-4.8 dB; and in the landscape holding state, the efficiency of the second antenna 20 at 2.42 GHz is-6 dB, with a degradation of 1.2 dB. The efficiencies of the second antenna in supporting B3, B1, B40, B41, and WIFI 2.4G frequency bands respectively in the free state and the landscape holding state are shown in Table 2.

TABLE 2
Efficiencies of the second antenna in supporting
B3, B1, B40, B41, and WIFI 2.4 G respectively in
the free state and the landscape holding state

| | | | Efficiency in | |
|---|---|---|---|---|
| | Frequency | Efficiency in | Landscape | Efficiency |
| | Band | Free State | holding State | Degradation |
| Second | B3 | −4.5 | −5 | 0.5 |
| Antenna | B1 | −5.9 | −7.4 | 1.5 |
| | B40 | −5.5 | −6.7 | 1.2 |
| | B41 | −3.8 | −5.5 | 1.7 |
| | WIFI 2.4 G | −4.3 | −5.8 | 1.5 |

It can be seen from Table 2 that the efficiency degradation of the second antenna 20 in supporting B3, B1, B40, B41, and WIFI 2.4G in the landscape holding state is about 1.5 dB. In addition, the second antenna 20 does not need to be additionally provided with a tuning switch 1321, and it can reuse the tuning switch 1321 of the first antenna 10 with low cost. In this case, high antenna efficiency can still be maintained, the communication performance is good, and the user's gaming experience can also be improved.

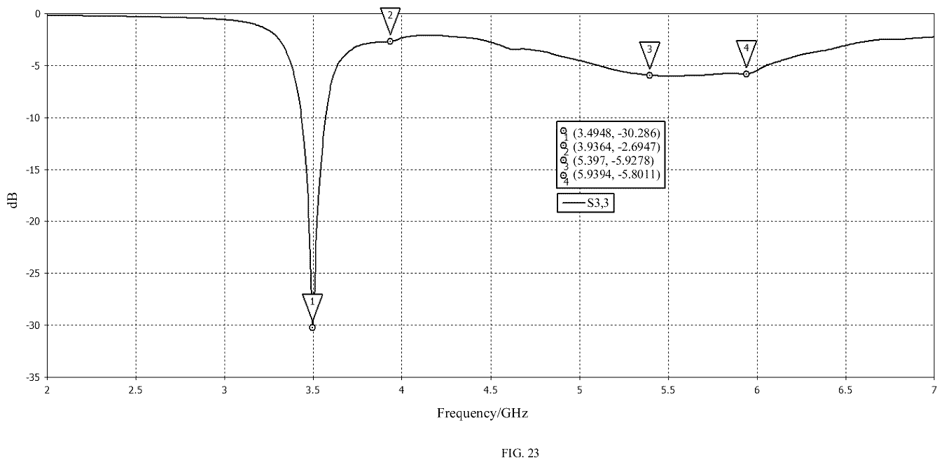

In an exemplary embodiment, referring to FIG. 4, the third radiator 31 is further provided with a third ground point G3. The third ground point G3 is arranged away from the second gap F2. The third antenna 30 further includes a third matching circuit M3 connected to each of the third feed source S3 and the third feed point K3. That is, a first terminal of the third matching circuit M3 is connected to the third feed source S3, and a second terminal of the third matching circuit M3 is connected to the third feed point K3. The third feed signal provided by the third feed source S3, after undergoing impedance matching by the third matching circuit M3, may be fed into the third radiator 31 through the third feed point K3, to excite the third radiator 31 and a part of the second radiator 21 to jointly generate multiple resonance modes to support the second frequency band and the WiFi 5G frequency band. The return loss of the third antenna 30 is shown in FIG. 23. The third antenna 30 may generate at least three resonance modes, such as a seventh resonance mode, an eighth resonance mode, and a ninth resonance mode, which can expand the bandwidth of the second frequency band and the WiFi 2.5G frequency band.

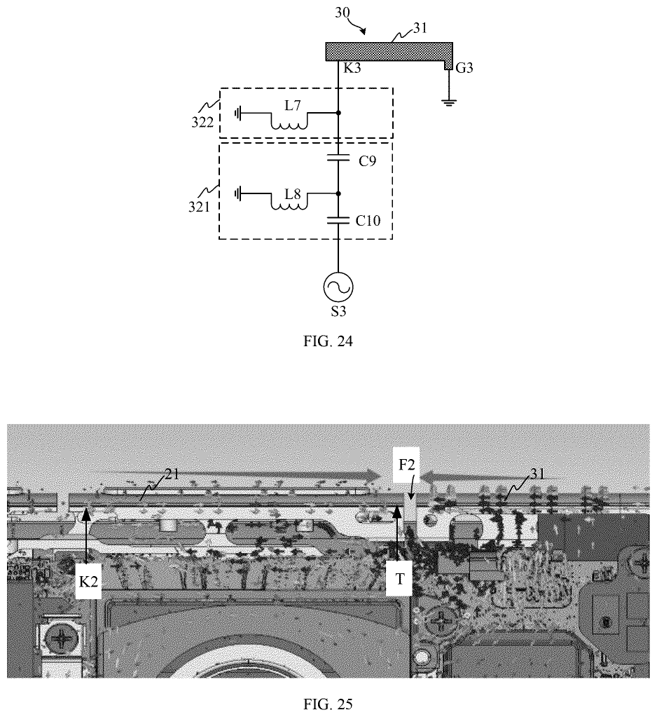

As illustrated in FIG. 24, the third matching circuit M3 may include a third matching unit 321 and a third tuning unit 322. A first terminal of the third matching unit 321 is connected to the third feed source S3, a second terminal of the third matching unit 321 is connected to each of the third feed point K3 and a second terminal of the third tuning unit 322, and a third terminal of the third matching unit 321 is connected to the common ground terminal. A first terminal of the third tuning unit 322 is connected to the common ground terminal, and the second terminal of the third tuning unit 322 is connected to the third feed point K3. Exemplarily, the third matching unit 321 may include at least a ninth capacitor C9, and a second terminal of the ninth capacitor C9 is used as the second terminal of the third matching unit 321. Optionally, the third matching unit 321 may further include an eighth inductor L8 and a tenth capacitor C10. A first terminal of the tenth capacitor C10 is connected to the third feed source S3, a second terminal of the tenth capacitor C10 is connected to each of a first terminal of the eighth inductor L8 and a first terminal of the ninth capacitor C9, and a second terminal of the eighth inductor L8 is connected to the common ground terminal. The third tuning unit 322 includes a seventh inductor L7. A first terminal of the seventh inductor L7 is connected to the common ground terminal, and a second terminal of the seventh inductor L7 is connected to the third feed point K3. It is notable that the specific circuit forms of the third matching unit and the third tuning unit are not limited to the foregoing examples, and there may also be other matching networks for impedance matching and resonance networks for frequency tuning.

The resonance modes of the third antenna 30 will be exemplarily described below with reference to the accompanying drawings based on the third matching circuit M3.

As illustrated in FIG. 25, the seventh resonance mode includes an IFA quarter-wavelength mode of a part of the third radiator from the second gap F2 to the third ground point G3, and a quarter-wavelength mode of a part of the second radiator from the second feed point K2 to the tuning point T. The seventh resonance mode is the primary mode of the second frequency band (e.g., N78 frequency band), and the seventh resonance mode may be excited by the ninth capacitor C9. The equivalent electrical length of the corresponding radiator in the seventh resonance mode is mainly controlled by the third tuning unit 322, such as the seventh inductor L7. By adjusting the tuning parameter of the third tuning unit 322, the bandwidth of the second frequency band can be expanded.

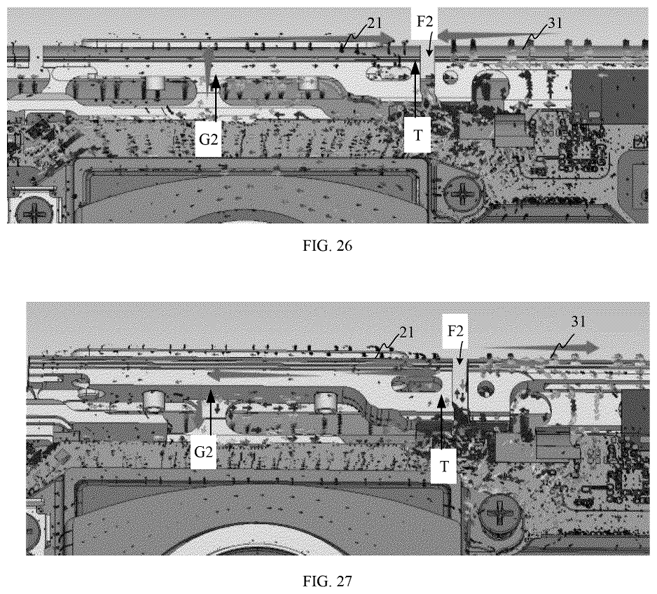

As illustrated in FIG. 26, the eighth resonance mode includes the IFA quarter-wavelength mode of the part of the third radiator from the second gap F2 to the third ground point G3, and a quarter-wavelength mode of a part of the second radiator from the ground strap point G2 to the tuning point T. The eighth resonance mode may be excited by the ninth capacitor C9, and the equivalent electrical length of the corresponding radiator in the eighth resonance mode is mainly controlled by the third tuning unit 322, such as the seventh inductor L7. By adjusting the tuning parameter of the third tuning unit 322, the bandwidth of the second frequency band can be expanded.

As illustrated in FIG. 27, the ninth resonance mode includes an IFA quarter-wavelength mode of a part of the third radiator from the second gap F2 to the third ground point G3, and a three-quarter-wavelength mode of a part of the second radiator from the ground strap point G2 to the tuning point T. The ninth resonance mode is the primary mode of 5.15 GHz-5.35 GHz in the WIFI 5G frequency band, and the ninth resonance mode may be excited by the ninth capacitor C9.

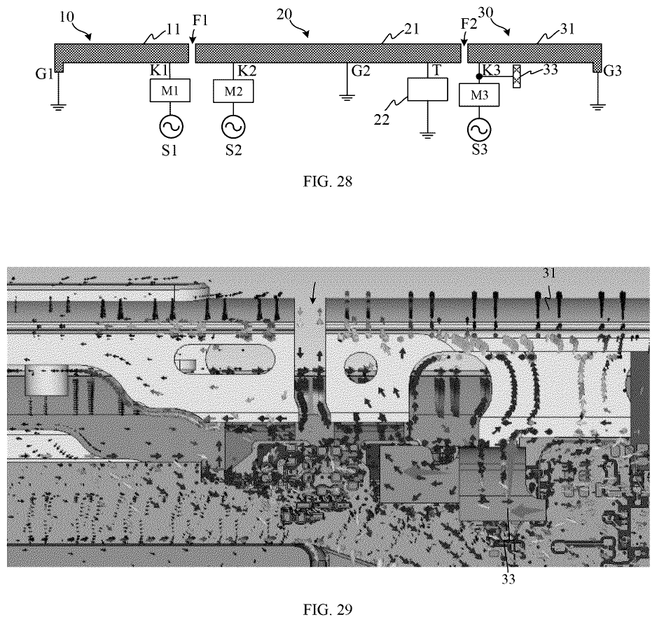

As illustrated in FIG. 28 and FIG. 29, in an exemplary embodiment, the third antenna 30 further includes a parasitic branch 33, and the parasitic branch 33 is connected to each of the third feed source S3 and the third feed point K3. Under the excitation of the third feed signal provided by the third feed source S3, the parasitic branch 33 is excited to generate a tenth resonance mode to support the WiFi 5G frequency band, as illustrated in FIG. 25.

In an exemplary embodiment, the parasitic branch 33 includes an FPC metal radiator. The third antenna 30 further includes a feed structure, and the feed structure includes a first conductive elastic piece and a second conductive elastic piece. The first conductive elastic piece is connected to each of the third feed source S3 and the third feed point K3, and the second conductive elastic piece is connected to the first conductive elastic piece 34 and the parasitic branch 33. It can be understood that two elastic pieces are arranged at the third feed point K3, with one elastic piece connected to the third radiator 31 of the metal middle frame, and the other elastic piece connected to the FPC metal radiator.

Referring to FIG. 29, the tenth resonance mode generated by the third antenna 30 includes a quarter-wavelength monopole mode from the free end of the parasitic branch 33 to the second conductive elastic piece. The parasitic branch 33 may include a free end and a connection end arranged opposite to each other. The connection end is connected to the second conductive elastic piece. It can be understood that the tenth resonance mode is a ¼ wavelength monopole mode from the end of the FPC metal radiator to the second conductive elastic piece, which is the primary mode of 5.65 GHZ-5.85 GHz in the WIFI 5G frequency band and may be excited by the ninth capacitor C9.

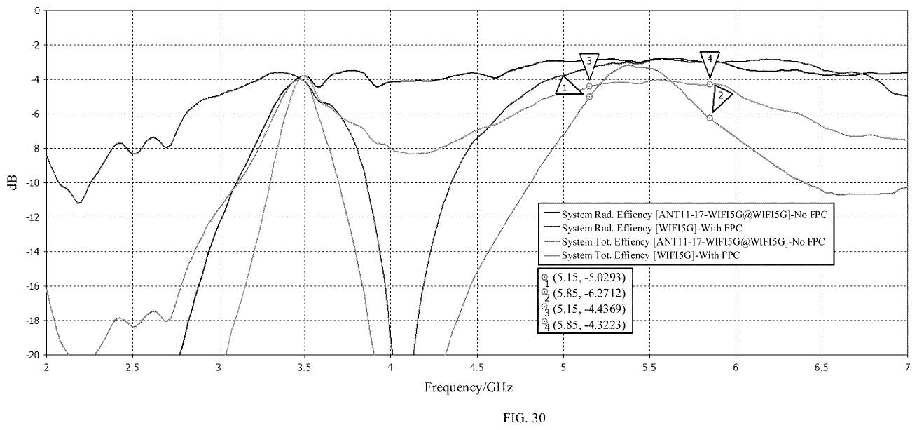

In the ninth resonance mode, that is, when no FPC metal radiator is added to the third antenna 30, the average efficiencies of 5.15 GHz-5.35 GHz and 5.65 GHz-5.85 GHz are −4 dB and −5.5 dB respectively, as illustrated in FIG. 30. In the tenth resonance mode, that is, after adding the FPC metal radiator to the third antenna 30, the average efficiencies of 5.15 GHz-5.35 GHz and 5.65 GHZ-5.85 GHz are −4.2 dB and −4.3 dB respectively. That is, after adding the FPC metal radiator, the average efficiency of WIFI 5G at 5.15 GHz-5.35 GHz is basically unchanged, and the average efficiency at 5.65 GHz-5.85 GHz is improved by 1.2 dB, which can improve the efficiency of WIFI 5G.

Compared with the ninth resonance mode (single third radiator 31), the third antenna 30 in this embodiment after adding the FPC metal radiator can broaden the bandwidth of WIFI 5G and further improve the efficiency of WIFI 5G.

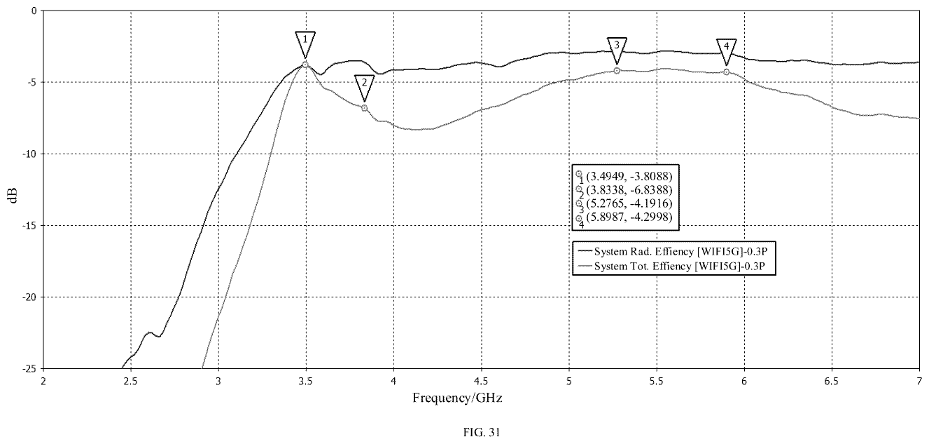

FIG. 31 is a diagram illustrating efficiencies of the third antenna in supporting the second frequency band and the WiFi 5G frequency band. It can be seen from FIG. 31 that the average efficiencies of the third antenna 30 in supporting N78 and WIFI 5G are both within-4.5 dB. When the antenna assembly is applied to the electronic device, the third antenna 30 may be used as a WiFi 5G antenna of the electronic device, as well as an ultra-high frequency primary antenna or an ultra-high frequency primary MIMO antenna.

The third antenna 30 provided by the embodiments of the present disclosure can generate four resonance modes, by using the face-to-face, aperture sharing multi-mode excitation and tuning technology of the second radiator 21 and the third radiator 31, and using the technology of providing elastic pieces at the common feed point to add the FPC radiator for the third antenna 30. This broadens the bandwidths of N78 and WIFI 5G, realizes wide-band coverage of N78 and WIFI 5G, and it can also improve the efficiency of the third antenna 30 in supporting the second frequency band and the WiFi 5G frequency band.

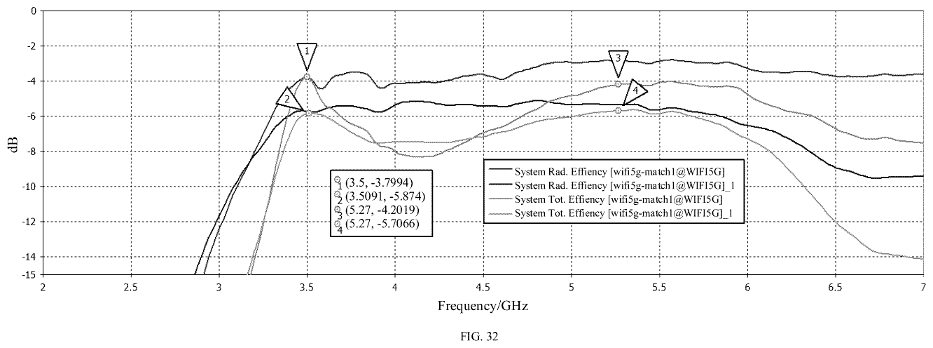

In addition, in the landscape holding state (e.g., in the game scenario), the efficiencies of the third antenna 30 are shown in FIG. 32. It can be seen from FIG. 32 that, in the free state, the efficiencies of the third antenna 30 at 3.5 GHZ and 5.27 GHz are −3.8 dB and −4.2 dB respectively; and in the landscape holding state, the efficiencies of the third antenna 30 at 3.5 GHz and 5.27 GHz is −5.87 dB and −5.7 dB respectively, decreasing by 2.1 dB and 1.5 dB respectively. The efficiencies of the third antenna 30 in supporting N78 and WIFI 5G frequency bands respectively in the free state and the landscape holding state are shown in Table 3.

TABLE 3
Efficiencies of the third antenna 30 in supporting N78 and WIFI 5
G respectively in the free state and the landscape holding state

| | | | Efficiency in | |
|---|---|---|---|---|
| | Frequency | Efficiency in | Landscape | Efficiency |
| | Band | Free State | holding State | Degradation |
| Third | N78 | −4.5 | −6.1 | 1.6 |
| Antenna | WIFI 5.2 G | −4.2 | −5.7 | 1.5 |
| | WIFI 5.8 G | −4.3 | −6.2 | 1.9 |

It can be seen from Table 3 that the efficiency degradation of the third antenna 30 in supporting N78 and WIFI 5G frequency bands in the landscape holding state is all within 2 dB. In the landscape holding state, the third antenna 30 can still maintain high antenna efficiency, has good communication performance, and can also improve the user's gaming experience.

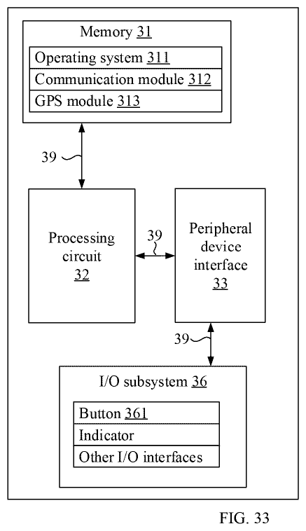

As illustrated in FIG. 33, further, the above electronic device is taken as a mobile phone for illustration. Specifically, as illustrated in FIG. 33, the mobile phone may include a memory 31 (which optionally includes one or more computer-readable storage media), a processing circuit 32, a peripheral device interface 33, the antenna assembly of the above embodiments, and an input/output (I/O) subsystem 36. These components optionally communicate therebetween through one or more communication buses or signal lines 39. Those skilled in the art may understand that the mobile phone shown in FIG. 33 does not constitute a limitation on the mobile phone, and the mobile phone may include more or fewer components than those shown, or combine some components, or adopt different arrangements of the components. Various components shown in FIG. 33 are implemented in hardware, software, or a combination of hardware and software, including one or more signal processing circuits and/or application-specific integrated circuits.

The memory 31 optionally includes a high-speed random access memory, and also optionally includes a non-volatile memory, such as one or more magnetic disk storage devices, flash memory devices, or other non-volatile solid-state memory devices. Exemplarily, the software components stored in the memory 31 include an operating system 311, a communication module (or instruction set) 312, a Global Positioning System (GPS) module (or instruction set) 313, and the like.

The processing circuit 32 and other control circuits may be used to control operations of the mobile phone. The processing circuit 32 may be based on one or more microprocessors, microcontrollers, digital signal processors, baseband processors, power management units, audio codec chips, application-specific integrated circuits, and the like. The processing circuit 32 may be configured to implement, in the mobile phone, a control algorithm for controlling the use of electronic devices. The processing circuit 32 may also issue control commands for controlling for example various switches in the electronic device.

The I/O subsystem 36 couples input/output peripheral devices on the mobile phone, such as a keypad and other input control devices, to the peripheral device interface 33. The I/O subsystem 36 optionally includes a touch screen, buttons, a tone generator, an accelerometer (a motion sensor), an ambient light sensor and other sensors, a light-emitting diode and other status indicators, data ports, and the like. Exemplarily, a user may control the operations of the mobile phone by providing commands via the I/O subsystem 36, and may use the output resources of the I/O subsystem 36 to receive status information and other outputs from the mobile phone. For example, the user may start or shut down the mobile phone by pressing the button 361.

The technical features of the above embodiments can be combined arbitrarily. To make the description concise, not all possible combinations of the technical features in the above embodiments are described. However, as long as there is no contradiction in the combination of these technical features, they should be considered as falling within the scope described in the disclosure. The above embodiments only illustrate several implementations of the present disclosure, and their descriptions are specific and detailed, but they cannot be understood as limiting the scope of the present disclosure. It is notable that several modifications and improvements can be made by those of ordinary skill in the art without departing from the concept of the present disclosure, which all fall within the scope of protection of the present disclosure. Therefore, the scope of protection of the present disclosure should be subject to the appended claims.

What is claimed is:

1. An antenna assembly, comprising:
a first antenna comprising a first radiator and a first feed source, wherein the first feed source is connected to a first feed point of the first radiator to excite the first radiator to support a first frequency band and a second frequency band;
a second antenna comprising a second radiator and a second feed source, wherein there is a first gap between a first terminal of the second radiator and the first radiator, and the second radiator is coupled with the first radiator through the first gap; the second radiator is provided with a second feed point and a ground strap point, the second feed point and the ground strap point are spaced apart from each other, the ground strap point is connected to a common ground terminal, and the second feed source is connected to the second feed point to excite the second radiator to support a third frequency band and a fourth frequency band, and to excite the first radiator and the second radiator to jointly support the third frequency band and the fourth frequency band, the fourth frequency band being a WiFi 2.4G frequency band or a Bluetooth 2.4G frequency band; and
a third antenna comprising a third radiator and a third feed source, wherein there is a second gap between the third radiator and a second terminal of the second radiator, the third radiator is coupled with the second radiator through the second gap, and the third feed source is connected to a third feed point of the third radiator to excite the third radiator and a part of the second radiator to support the second frequency band and a WiFi 5G frequency band.

2. The antenna assembly of claim 1, wherein the first antenna further comprises a first matching circuit;
wherein the first feed source is connected to the first feed point through the first matching circuit, to excite the first radiator to generate a first resonance mode for supporting a low-frequency band and a second resonance mode for supporting an ultra-high frequency band.

3. The antenna assembly of claim 2, wherein the first radiator is further provided with a first ground point connected to the common ground terminal, and the first feed point is arranged between the first ground point and the first gap;
wherein the first resonance mode comprises an IFA quarter-wavelength mode of a part of the first radiator from the first gap to the first ground point; and
the second resonance mode comprises an IFA seven-quarter-wavelength mode of a part of the first radiator from the first gap to the first ground point.

4. The antenna assembly of claim 2, wherein the first matching circuit comprises:
a first matching unit, wherein a first terminal of the first matching unit is connected to the first feed source; and
a first tuning unit, wherein the first tuning unit is connected to each of a second terminal of the first matching unit, the first feed point, and the common ground terminal, and is configured to adjust an equivalent electrical length of the first radiator.

5. The antenna assembly of claim 4, wherein the first tuning unit comprises a tuning switch and a plurality of tuning devices, a common terminal of the tuning switch is connected to each of the first matching unit and the first feed point, each selection terminal of the tuning switch is connected to a first terminal of a corresponding one of the plurality of tuning devices, and a second terminal of each of the plurality of tuning devices is connected to the common ground terminal.

6. The antenna assembly of claim 1, wherein the second radiator is further provided with a tuning point, the second feed point is arranged close to the first gap, the tuning point is arranged close to the second gap, and the ground strap point is arranged between the second feed point and the tuning point;
the second antenna further comprises:
a tuning circuit, wherein a first terminal of the tuning circuit is connected to the common ground terminal, and a second terminal of the tuning circuit is connected to the tuning point; and
a second matching circuit, wherein a first terminal of the second matching circuit is connected to the second feed source, and a second terminal of the second matching circuit is connected to the second feed point.

7. The antenna assembly of claim 6, wherein the second feed source is connected to the second feed point through the second matching circuit, to excite the second radiator to generate a third resonance mode and a fifth resonance mode for supporting the third frequency band and the fourth frequency band, and to excite the first radiator and the second radiator to jointly generate a fourth resonance mode and a sixth resonance mode for supporting the third frequency band and the fourth frequency band.

8. The antenna assembly of claim 7, wherein the third resonance mode comprises a balanced mode of a part of the second radiator from the tuning point to the second feed point;
the fourth resonance mode comprises an RM mode of a part of the second radiator from the first gap to the tuning point, and a three-quarter-wavelength mode of a part of the first radiator from the first ground point of the first radiator to the first gap;
the fifth resonance mode comprises an IFA quarter-wavelength mode of a part of the second radiator from the first gap to the ground strap point; and
the sixth resonance mode comprises an RM mode of a part of the second radiator from the tuning point to the first gap, and a three-quarter-wavelength mode of a part of the first radiator from the first gap to the first ground point.

9. The antenna assembly of claim 6, wherein the tuning circuit comprises a first tuning capacitor and a second tuning capacitor, a first terminal of the first tuning capacitor is connected to the tuning point, a second terminal of the first tuning capacitor is connected to a first terminal of the second tuning capacitor, and a second terminal of the second tuning capacitor is connected to the common ground terminal.

10. The antenna assembly of claim 1, wherein a width of a part of the second radiator where the ground strap point is located ranges from 1.5 mm to 2.5 mm.

11. The antenna assembly of claim 1, wherein the third frequency band ranges from 1.71 GHz to 2.7 GHz.

12. The antenna assembly of claim 1, wherein the third antenna further comprises a third matching circuit connected to each of the third feed source and the third feed point;
wherein the third feed source is connected to the third feed point through the third matching circuit, to enable the third radiator and the part of the second radiator to generate a seventh resonance mode, an eighth resonance mode, and a ninth resonance mode for supporting the second frequency band and the WiFi 5G frequency band.

13. The antenna assembly of claim 12, wherein the third radiator is further provided with a third ground point;
wherein the seventh resonance mode comprises an IFA quarter-wavelength mode of a part of the third radiator from the second gap to the third ground point, and a quarter-wavelength mode of a part of the second radiator from the second feed point to the tuning point;
the eighth resonance mode comprises the IFA quarter-wavelength mode of the part of the third radiator from the second gap to the third ground point, and a quarter-wavelength mode of a part of the second radiator from the ground strap point to the tuning point; and
the ninth resonance mode comprises the IFA quarter-wavelength mode of the part of the third radiator from the second gap to the third ground point, and a three-quarter-wavelength mode of a part of the second radiator from ground strap point to the tuning point.

14. The antenna assembly of claim 1, wherein the third antenna further comprises a parasitic branch, and the parasitic branch is connected to each of the third feed source and the third feed point;
the parasitic branch is configured to, under excitation of a third feed signal provided by the third feed source, generate a tenth resonance mode for supporting the WiFi 5G frequency band.

15. The antenna assembly of claim 14, wherein the tenth resonance mode comprises a quarter-wavelength monopole mode of the parasitic branch.

16. The antenna assembly of claim 14, wherein the parasitic branch comprises an FPC metal radiator.

17. The antenna assembly of claim 14, wherein the third antenna further comprises a feed structure comprising:
a first conductive elastic piece, connected to each of the third feed source and the third feed point; and
a second conductive elastic piece, connected to each of the third feed point and the parasitic branch.

18. An antenna assembly, comprising:
a first antenna comprising a first radiator and a first feed source, wherein the first feed source is connected to a first feed point of the first radiator, and the first radiator is configured to support a first frequency band and a second frequency band under a first excitation signal generated by the first feed source;
a second antenna comprising a second radiator and a second feed source, wherein there is a first gap between a first terminal of the second radiator and the first radiator, and the second radiator is capable of being coupled with the first radiator through the first gap; the second radiator is provided with a second feed point and a ground strap point, the second feed point and the ground strap point are spaced apart from each other, the ground strap point is connected to a common ground terminal, and the second feed source is connected to the second feed point; the second radiator is configured to support a third frequency band and a fourth frequency band under a second excitation signal generated by the second feed source, and the first radiator and the second radiator are further configured to, under the second excitation signal generated by the second feed source, jointly support the third frequency band and the fourth frequency band, the fourth frequency band being a WiFi 2.4G frequency band or a Bluetooth 2.4G frequency band; and
a third antenna comprising a third radiator and a third feed source, wherein there is a second gap between the third radiator and a second terminal of the second radiator, the third radiator is capable of being coupled with the second radiator through the second gap, the third feed source is connected to a third feed point of the third radiator, and the third radiator and a part of the second radiator are configured to support the second frequency band and a WiFi 5G frequency band under a third excitation signal generated by the third feed source.

19. An electronic device, comprising the antenna assembly comprising:
a first antenna comprising a first radiator and a first feed source, wherein the first feed source is connected to a first feed point of the first radiator to excite the first radiator to support a first frequency band and a second frequency band;
a second antenna comprising a second radiator and a second feed source, wherein there is a first gap between a first terminal of the second radiator and the first radiator, and the second radiator is capable of being coupled with the first radiator through the first gap; the second radiator is provided with a second feed point and a ground strap point, the second feed point and the ground strap point are spaced apart from each other, the ground strap point is connected to a common ground terminal, and the second feed source is connected to the second feed point to excite the second radiator to support a third frequency band and a fourth frequency band, and to excite the first radiator and the second radiator to jointly support the third frequency band and the fourth frequency band, the fourth frequency band being a WiFi 2.4G frequency band or a Bluetooth 2.4G frequency band; and
a third antenna comprising a third radiator and a third feed source, wherein there is a second gap between the third radiator and a second terminal of the second radiator, the third radiator is capable of being coupled with the second radiator through the second gap, and the third feed source is connected to a third feed point of the third radiator to excite the third radiator and a part of the second radiator to support the second frequency band and a WiFi 5G frequency band.

20. The electronic device of claim 19, wherein the electronic device further comprises:
a middle frame, wherein the middle frame comprises a top side-frame, a first lateral side-frame, a bottom side-frame, and a second lateral side-frame connected in sequence, the first radiator, the second radiator, and the third radiator are all located on the first lateral side-frame or the second lateral side-frame, and the third radiator is arranged close to the top side-frame.
